(19) United States
(12) Patent Application Publication
(10) Pub. No.: US 2026/0270027 A1
(43) Pub. Date: Sep. 10, 2026

(54) METHODS AND APPARATUS OF SRS RESOURCE MAPPING HOPPING

(71) Applicant: LENOVO (BEIJING) LIMITED, Beijing (CN)

(72) Inventors: Yi Zhang, Beijing (CN); Chenxi Zhu, Fairfax, VA (US); Wei Ling, Beijing (CN); Bingchao Liu, Beijing (CN); Lingling Xiao, Beijing (CN)

(21) Appl. No.: 18/848,596

(22) PCT Filed: Jul. 22, 2022
(86) PCT No.: PCT/CN2022/107276

§ 371 Date: Sep. 19, 2024

(51) Int. Cl. H04L 5/00; H04B 1/7143; H04B 1/715

(52) U.S. Cl. CPC H04L 5/0094; H04B 1/7143; H04B 1/715; H04B 2001/7152

(57) ABSTRACT

Methods and apparatus of SRS resource mapping hopping for cross-SRS interference mitigation are disclosed. The apparatus includes a receiver that receives a configuration signalling for Sounding Reference Signal (SRS) resource mapping hopping; a processor that determines a hopping set for SRS resource mapping hopping, wherein the hopping set comprises a set of Cyclic Shift (CS) values, a set of transmission combs, and/or a set of initial frequency locations for frequency hopping; and a transmitter that transmits an SRS with hopping in the hopping set based on a randomized SRS resource mapping.

### FIELD

The subject matter disclosed herein relates generally to wireless communication and more particularly relates to, but not limited to, methods and apparatus of Sounding Reference Signal (SRS) resource mapping hopping for cross-SRS interference mitigation.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Bandwidth Part (BWP), Cycling Shift (CS), Channel State Information (CSI), Frequency Division Duplex (FDD), Frequency Division Multiple Access (FDMA), Index/Identifier (ID), Information Element (IE), Multiple Input Multiple Output (MIMO), Physical Resource Block (PRB), Resource Block (RB), Radio Resource Control (RRC), Signal-to-Interference-Plus-Noise Ratio (SINR), Sounding Reference Signal (SRS), Time-Division Duplexing (TDD), Transmission Reception Point (TRP), Frequency Range 1 (FR1), Frequency Range 2 (FR2), Precoder Matrix Indicator (PMI), Technical Specification (TS), Coherent Joint Transmission (CJT), Joint Transmission (JT), Transmission Comb (TC).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHZ) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

In Release 18 of 3GPP specifications, enhancements on downlink MIMO that facilitate the use of large antenna array, for both FR1 and FR2, are needed to fulfill the demand for evolution of NR deployments.

As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments. Sounding Reference Signal (SRS) enhancement targeting TDD coherent JT is agreed as part of MIMO enhancement.

### SUMMARY

Methods and apparatus of SRS resource mapping hopping for cross-SRS interference mitigation are disclosed.

According to a first aspect, there is provided an apparatus, including: a receiver that receives a configuration signalling for Sounding Reference Signal (SRS) resource mapping hopping; a processor that determines a hopping set for SRS resource mapping hopping, wherein the hopping set comprises a set of Cyclic Shift (CS) values, a set of transmission combs, and/or a set of initial frequency locations for frequency hopping; and a transmitter that transmits an SRS with hopping in the hopping set based on a randomized SRS resource mapping.

According to a second aspect, there is provided an apparatus, including: a transmitter that transmits a configuration signalling for Sounding Reference Signal (SRS) resource mapping hopping; a processor that determines a hopping set for SRS resource mapping hopping, wherein the hopping set comprises a set of Cyclic Shift (CS) values, a set of transmission combs, and/or a set of initial frequency locations for frequency hopping; and a receiver that receives an SRS with hopping in the hopping set based on a randomized SRS resource mapping.

According to a third aspect, there is provided a method, including: receiving, by a receiver, a configuration signalling for Sounding Reference Signal (SRS) resource mapping hopping; determining, by a processor, a hopping set for SRS resource mapping hopping, wherein the hopping set comprises a set of Cyclic Shift (CS) values, a set of transmission combs, and/or a set of initial frequency locations for frequency hopping; and transmitting, by a transmitter, an SRS with hopping in the hopping set based on a randomized SRS resource mapping.

According to a fourth aspect, there is provided a method, including: transmitting, by a transmitter, a configuration signalling for Sounding Reference Signal (SRS) resource mapping hopping; determining, by a processor, a hopping set for SRS resource mapping hopping, wherein the hopping set comprises a set of Cyclic Shift (CS) values, a set of transmission combs, and/or a set of initial frequency locations for frequency hopping; and receiving, by a receiver, an SRS with hopping in the hopping set based on a randomized SRS resource mapping.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of inter-TRP cross-SRS interference scenario where SRS resource mapping hopping may be used to mitigate cross-SRS interference in accordance with some implementations of the present disclosure.

FIG. 5 is a flow chart illustrating steps of SRS resource mapping hopping by UE in accordance with some implementations of the present disclosure; and

FIG. 6 is a flow chart illustrating steps of SRS resource mapping hopping by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

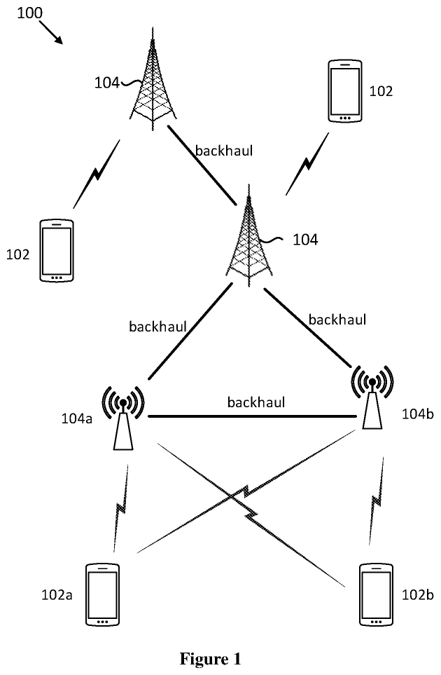

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

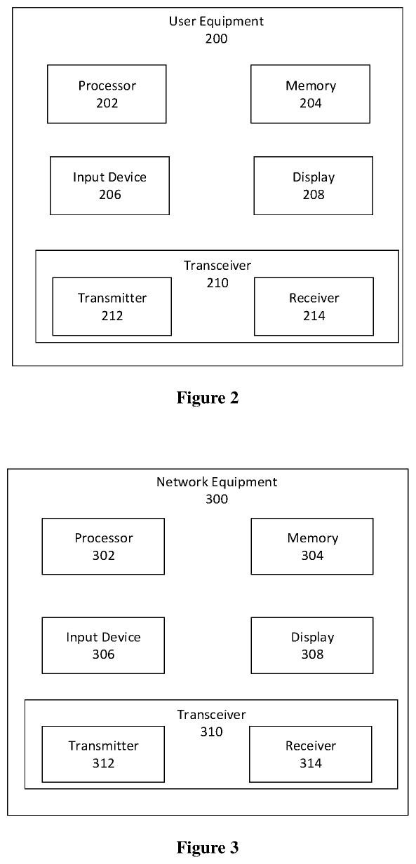

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

Sounding Reference Signal (SRS) is an uplink (UL) physical signal used by user equipment (UE) for uplink channel sounding, including synchronization and CSI estimation. SRS gives information about the combined effect of multipath fading, scattering, Doppler and power loss of transmitted signal. The base station or gNB may estimate the channel quality using this reference signal and manages further resource scheduling, beam management, and power control of signal.

For TDD system, SRS may also be used to obtain downlink CSI by exploiting channel reciprocity. SRS based DL CSI acquisition scheme has the benefit of lower CSI feedback overhead and higher CSI precision, compared with quantized PMI feedback. For cell-edge UEs, the uplink SINR and channel quality could be too low to perform SRS-based channel measurement with sufficient resolution, especially for power-limited UEs. Thus, it is important to make SRS enhancement to manage inter-TRP cross-SRS interference. Interference randomization is one kind of popular schemes, which can be realized by SRS resource mapping hopping, or hopping on SRS resource mapping, which may also be referred to as SRS resource hopping for simplicity.

In general, the SRS resource mapping hopping can include hopping on parameters of cyclic shifting (CS), transmission comb (TC, or Comb, for simplicity), and/or initial frequency location in the case of frequency hopping. Several SRS resource mapping hopping schemes are proposed to mitigate inter-TRP cross-SRS interference for CJT.

In the present 3GPP technical specifications TS 38.211, the SRS is described as follows:
An SRS resource is configured by the SRS-Resource IE or the SRS-PosResource IE and consists of

$${N}_{a p}^{SRS} ∈ \{ 1 , 2 , 4 \} antenna ports {\{ {p}_{i} \}}_{i = 0}^{{N}_{ap}^{SRS} - 1} ,$$

where the number of antenna ports is given by the higher layer parameter nrofSRS-Ports if configured, otherwise

$${N}_{ap}^{SRS} = 1 ,$$

and pᵢ=1000+i when the SRS resource is in a SRS resource set with higher-layer parameter usage in SRS-ResourceSet not set to ‘nonCodebook’, or determined according to [6, TS 38.214] when the SRS resource is in a SRS resource set with higher-layer parameter usage in SRS-ResourceSet set to ‘nonCodebook’

$${N}_{symb}^{SRS} ∈ \{ 1 , 2 , 4 , 8 , 10 , 12 , 14 \}$$

contained in the higher layer parameter resourceMapping
l₀, the starting position in the time domain given by

$${l}_{0} = {N}_{symb}^{slot} - 1 - {l}_{offset}$$

where the offset l_{offset}∈{0, 1, . . . , 13} counts symbols backwards from the end of the slot and is given by the field startPosition contained in the higher layer parameter resourceMapping and

$${l}_{offset} \geq {N}_{symb}^{SRS} - 1$$

k₀, the frequency-domain starting position of the sounding reference signal

The sounding reference signal sequence for an SRS resource shall be generated according to

$${r}^{( {p}_{i} )} ( n , {l}^{′} ) = {r}_{u , v}^{( {α}_{i} , δ )} ( n )$$

$$0 \leq n \leq {M}_{sc , b}^{SRS} - 1$$

$${l}^{′} ∈ \{ 0 , 1 , … , {N}_{symb}^{SRS} - 1 \}$$

where

$${M}_{sc , b}^{SRS}$$

is given by clause 6.4.1.4.3,

$${r}_{u , v}^{( α , δ )} ( n )$$

is given vy clause 5.2.2 with δ=log₂(K_{TC}) and the transmission comb number K_{TC}∈{2, 4, 8} is contained in the higher-layer parameter transmissionComb. The cyclic shift αᵢ for antenna port pᵢ is given as

$${α}_{i} = 2 π \frac{{n}_{SRS}^{cs , i}}{{n}_{SRS}^{cs , ma x}}$$

$${n}_{SRS}^{cs , i} = \{ \begin{matrix}( {n}_{SRS}^{cs} + \frac{{n}_{SRS}^{cs , m ax} ⌊ ( {p}_{i} - 1000 ) / 2 ⌋}{{N}_{ap}^{SRS} / 2} ) mod {n}_{SRS}^{cs , m ax} & if {N}_{ap}^{SRS} = 4 and {n}_{SRS}^{cs , m ax} = 6 \\ ( {n}_{SRS}^{cs} + \frac{{n}_{SRS}^{cs , m ax} ( {p}_{i} - 1000 )}{{N}_{ap}^{SRS}} ) mod {n}_{SRS}^{cs , m ax} & otherwise\end{matrix} ,$$

where

$${n}_{SRS}^{cs} ∈ \{ 0 , 1 , … , {n}_{SRS}^{cs , ma x} - 1 \}$$

is contained in the higher layer parameter transmissionComb. The maximum number of cyclic shifts

$${n}_{SRS}^{cs , m ax}$$

are given by Table 6.4.1.4.2-1.

The sequence group

$$u = ( {f}_{g h} ( {n}_{s , f}^{μ} , {l}^{′} ) + {n}_{ID}^{SRS} ) mod 30$$

and the sequence number v in clause 5.2.2 depends on the higher-layer parameter groupOrSequenceHopping in the SRS-Resource IE or the SRS-PosResource IE. The SRS sequence identity

$${n}_{ID}^{SRS}$$

is given by the higher layer parameter sequenceId in the SRS-Resource IE, in which case

$${n}_{ID}^{SRS} ∈ \{ 0 , 1 , … , 1023 \} ,$$

or the SRS-PosResource-r16 IE, in which case

$${n}_{ID}^{SRS} ∈ \{ 0 , 1 , … , 65535 \} .$$

The quantity

$${l}^{′} ∈ \{ 0 , 1 , … , {N}_{symb}^{SRS} - 1 \}$$

is the OFDM symbol symbol number within the SRS resource.
if groupOrSequenceHopping equals ‘neither’, neither group, nor sequence hopping shall be used and

$${f}_{gh} ( {n}_{s , f}^{μ} , {l}^{′} ) = 0$$

$$v = 0$$

if groupOrSequenceHopping equals ‘groupHopping’, group hopping but not sequence hopping shall be used and

$${f}_{g h} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30$$

$$v = 0$$

where the pseudo-random sequence c (i) is defined by clause 5.2.1 and shall be initialized with

$${c}_{init} = {n}_{ID}^{SRS}$$

at the beginning of each radio frame.
if groupOrSequenceHopping equals ‘sequenceHopping’, sequence hopping but not group hopping shall be used and

$${f}_{gh} ( {n}_{s , f}^{μ} , {l}^{′} ) = 0 \\ v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

where the pseudo-random sequence c(i) is defined by clause 5.2.1 and shall be initialized with

$${c}_{init} = {n}_{ID}^{SRS}$$

at the beginning of each radio frame.

TABLE 6.4.1.4.2-1
$Maximum number of cyclic shifts {n}_{SRS}^{cs , max} as a function of {K}_{TC} .$

| K_{TC} | ${n}_{SRS}^{cs , ma x}$ |
|---|---|
| 2 | 8 |
| 4 | 12 |
| 8 | 6 |

When SRS is transmitted on a given SRS resource, the sequence r^{(p}^{ᵢ}⁾(n, l′) for each OFDM symbol l′ and for each of the antenna ports of the SRS resource shall be multiplied with the amplitude scaling factor β_{SRS} in order to conform to the transmit power specified in [5, 38.213] and mapped in sequence starting with r^{(p}^{ᵢ}⁾(0, l′) to resource elements (k, l) in a slot for each of the antenna ports pᵢ according to

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix}$$

The length of the sounding reference signal sequence is given by

$${M}_{sc , b}^{SRS} = {m}_{SRS , b} {N}_{sc}^{RB} / ( {K}_{TC} {P}_{F} )$$

where m_{SRS,b} is given by a selected row of Table 6.4.1.4.3-1 with b=B_{SRS} where B_{SRS}ϵ={0, 1, 2, 3} is given by the field b-SRS contained in the higher-layer parameter freqHopping if configured, otherwise B_{SRS}=0. The row of the table is selected according to the index C_{SRS}ϵ{0, 1, . . . , 63} given by the field c-SRS contained in the higher-layer parameter freqHopping. The quantity P_{F} is given by the higher-layer parameter FreqScalingFactor if configured, otherwise P_{F}=1. When FreqScalingFactor is configured, the UE expects the length of the SRS sequence to be a multiple of 6.

The frequency-domain starting position

$${k}_{0}^{( {p}_{i} )}$$

is defined by

$${k}_{0}^{( {p}_{i} )} = {\overline{k}}_{0}^{( {p}_{i} )} + {n}_{offset}^{FH} + {n}_{offset}^{RPFS}$$

$$where$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} \\ {k}_{TC}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , m ax} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and \\ & {n}_{SRS}^{cs} ∈ \{ {n}_{SRS}^{cs , ma x} / 2 , , {n}_{SRS}^{cs , ma x} - 1 \} \\ {\overline{k}}_{TC} & otherwise\end{matrix} \\ {n}_{offset}^{FH} = {\sum }_{b = 0}^{{B}_{SRS}} {m}_{SRS , b} {N}_{sc}^{RB} {n}_{b} \\ {n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

and
   k_{F}∈{0, 1, . . . , P_{F}−1} is given by the higher-layer parameter StartRBIndex if configured, otherwise k_{F}=0;
   kₕₒₚ is given by Table 6.4.1.4.3-3 with

$$\begin{matrix}{\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F} \\ {N}_{{b}_{hop}} = 1\end{matrix}$$

if the higher-layer parameter EnableStartRBHopping is configured, otherwise kₕₒₚ=0.

If

$${N}_{BWP}^{start} \leq {n}_{shift}$$

the reference point for

$${k}_{0}^{( {p}_{i} )} = 0$$

is subcarrier 0 in common resource block 0, otherwise the reference point is the lowest subcarrier of the BWP.

If the SRS is configured by the IE SRS-PosResource, the quantity

$${k}_{offset}^{{l}^{′}}$$

is given by Table 6.4.1.4.3-2, otherwise

$${k}_{offset}^{{l}^{′}} = 0 .$$

The frequency domain shift value n_{shift} adjusts the SRS allocation with respect to the reference point grid and is contained in the higher-layer parameter freqDomainShift in the SRS-Resource IE or the SRS-PosResource IE. The transmission comb offset K_{TC}={0, 1, . . . , K_{TC}−1} is contained in the higher-layer parameter transmissionComb in the SRS-Resource IE or the SRS-PosResource IE and ng is a frequency position index.

Frequency hopping of the sounding reference signal is configured by the parameter bₕₒₚ∈{0, 1, 2, 3}, given by the field b-hop contained in the higher-layer parameter freqHopping if configured, otherwise bₕₒₚ=0.

If bₕₒₚ≥B_{SRS}, frequency hopping is disabled and the frequency position index np remains constant (unless re-configured) and is defined by

$${n}_{b} = ⌊ 4 {n}_{RRC} / {m}_{SRS , b} ⌋ mod {N}_{b}$$

for all

$${N}_{symb}^{SRS}$$

OFDM symbols of the SRS resource. The quantity RRC is given by the higher-layer parameter freqDomainPosition if configured, otherwise n_{RRC}=0, and the values of m_{SRS,b} and N_{b} for b=B_{SRS} are given by the selected row of Table 6.4.1.4.3-1 corresponding to the configured value of C_{SRS}.

If bₕₒₚ<B_{SRS}, frequency hopping is enabled and the frequency position indices ng are defined by

$${n}_{b} = \{ \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix}$$

where No is given by Table 6.4.1.4.3-1,

$${F}_{b} ( {n}_{SRS} ) = \{ \begin{matrix}( {N}_{b} / 2 ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋ & if {N}_{b} even \\ ⌊ {N}_{b} / 2 ⌋ ⌊ {n}_{S R S} / {\prod }_{{b}^{′} = {b}_{hop}}^{b - 1} {N}_{{b}^{′}} ⌋ & if {N}_{b} odd\end{matrix}$$

and where N_{b}_{ₕₒₚ}=1 regardless of the value of No. The quantity n_{SRS} counts the number of SRS transmissions. For the case of an SRS resource configured as aperiodic by the higher-layer parameter resourceType, it is given by n_{SRS}=[l′/R] within the slot in which the

$${N}_{symb}^{SRS}$$

symbol SRS resource is transmitted. The quantity

$$R \leq {N}_{symb}^{SRS}$$

is the repetition factor given by the field repetitionFactor if configured, otherwise

$$R = {N}_{symb}^{SRS} .$$

For the case of an SRS resource configured as periodic or semi-persistent by the higher-layer parameter resourceType, the SRS counter is given by

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

for slots that satisfy

$$( {N}_{slot}^{frame , μ} {n}_{f} + {n}_{s , f}^{μ} - {T}_{offset} ) mod {T}_{SRS} = 0.$$

The periodicity T_{SRS} in slots and slot offset T_{offset} are given in clause 6.4.1.4.4.

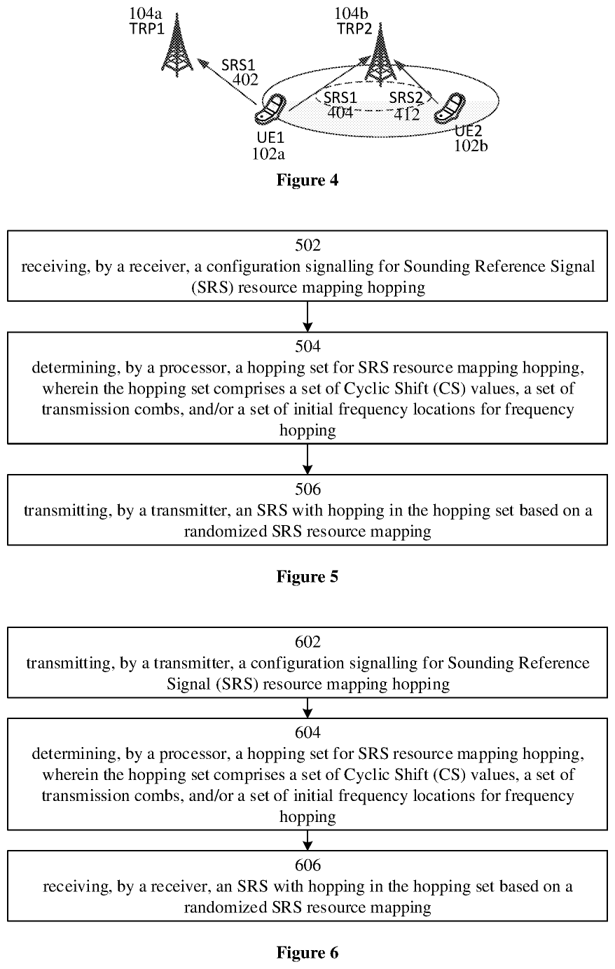

FIG. 4 is a schematic diagram illustrating an example of inter-TRP cross-SRS interference scenario where SRS resource mapping hopping may be used to mitigate cross-SRS interference in accordance with some implementations of the present disclosure. As shown in FIG. 4, UE1 102a is in coverage of both TRP1 104a and TRP2 104b, and UE2 102b is in coverage of TRP2 104b; and coherent joint transmission (CJT) is achieved by UE1 102a with transmission of SRS1 402 to TRP1 104a and transmission of SRS1 404 to TRP2 104b. UE2 102b transmits SRS2 412 to TRP2 104b. SRS1 404 from CJT UE1 102a in coverage of TRP1 104a may receive interference of SRS2 412 from UE2 102b in coverage of TRP2 104b. The inference may be severe when UE1 102a is further from TRP2 104b than UE2 102b.

To mitigate inter-TRP cross-SRS interference, candidate schemes are proposed, including randomized frequency domain and code domain resource mapping for SRS transmission, e.g., frequency hopping, Comb hopping (i.e., hopping on the parameter of transmission comb), CS hopping (i.e., hopping on the parameter of CS). In the disclosure, optimized hopping schemes are proposed to further improve interference mitigation effect and hopping efficiency. The hopping set for SRS resource mapping, time granularity and pseudo randomized pattern for hopping, and enabling signalling are discussed in detail.

### Hopping Set for SRS Resource Mapping

For randomized SRS resource mapping, there are two principles for designing the hopping set for CS, Comb, and/or initial frequency location in the case of frequency hopping.

In principle, a hopping set with a larger size may provide smaller collision probability and thus better interference mitigation effect. Thus, the first principle is to use or configure relative larger hopping set size for SRS resource mapping.

From another point of view, interference situation is not changed in the case of hopping between the same hopping elements and thus this is not efficient on account of needing more hopping times. Thus, the second principle is to include smaller number of overlapping hopping elements in the same hopping set, thereby improving hopping efficiency.

SRS resource mapping hopping schemes, including hopping sets for different combinations of CS hopping, and/or Comb hopping and/or initial frequency location hopping in the case of frequency hopping, are designed based on these two principles.

### Hopping Set for CS Hopping or Comb Hopping

In legacy system, the cyclic shift

$${n}_{SRS}^{cs} ∈ \{ 0 , 1 , … , {n}_{SRS}^{cs , ma x} - 1 \}$$

and transmission comb number K_{TC}∈{2, 4, 8} are contained in the higher-layer parameter transmissionComb, where the maximum number of cyclic shifts n_{SRS}^{cs,max} is a function of Comb number K_{TC} as defined by Table 6.4.1.4.2-1.

For 2 SRS ports, equal CS spacing and same Comb may be used for different antenna ports, e.g.,

$${n}_{SRS}^{cs , ma x} / {N}_{ap}^{SRS} , where {N}_{ap}^{SRS}$$

is the number of antenna ports for SRS, or SRS port number; for 4 SRS ports, combinations of CS and Comb (Comb may be different for different SRS ports) may be used for one SRS resource, where the specific formula is defined for CS and Comb as described in TS 38.211.

For randomized SRS resource mapping with CS hopping, the CS value(s) for the SRS port(s) may cycle in one set, which is not the fixed RRC configured

$${n}_{SRS}^{cs}$$

as in the legacy system. As a simple scheme with CS hopping, the hopping set which includes a set of CS values (which may also be referred to as the CS hopping set) may be

$$\{ 0 , 1 , … , {n}_{SRS}^{cs , m ax} - 1 \}$$

and the size of the CS hopping set is

$${n}_{SRS}^{cs , ma x} ,$$

which may be determined based on the configured Comb value by Table 6.4.1.4.2-1 in TS 38.211. Thus, the cross-SRS interference may be reduced when an SRS resource takes different CS values by hopping with the same base sequence in different transmission occasions. Here, CS hopping scheme is defined for the first SRS port. The CS value(s) for the other SRS port(s) may be derived based on legacy scheme and CS value of the first SRS port. The same mechanism may be used for the following enhanced schemes.

A similar scheme may be provided for Comb hopping, where Comb value(s) for the SRS port(s) may hop in the set {0, 1, . . . , K_{TC}−1}. That is, the hopping set for Comb hopping, which includes a set of transmission combs, may contain Comb values from 0 to (K_{TC}−1). Here, Comb hopping scheme is defined for the first SRS port. The Comb value(s) for the other SRS port(s) may be derived based on legacy scheme and Comb value of the first SRS port. The same mechanism may be used for the following enhanced schemes.

As a first enhanced scheme of CS hopping, to improve hopping efficiency in the case of multiple SRS ports, the used CS values for multiple SRS ports may be excluded from the next hopping set. In an example, Comb value is configured as ‘2’ and

$${n}_{SRS}^{cs , ma x} = 8$$

based on Table 6.3.1.3.2-1. When CS values {0, 4} are used for this SRS transmission, or are currently in-use, for two SRS ports in one SRS transmission, these two CS values are not used, or are excluded, for the next SRS transmission with CS hopping. The possible hopping elements in the CS hopping set include CS values {1, 5}, {2, 6}, {3, 7}, {5, 1}, {6, 2}, {7, 3} for 2 SRS ports, i.e., the CS values {0, 4} that are in-use prior to hopping are excluded from the hopping set. Thus, in the first enhanced scheme, the CS hopping set size is

$$( {n}_{SRS}^{cs , ma x} - {N}_{ap}^{SRS} ) ,$$

that is, the CS hopping set includes CS values from 0 to

$$( {n}_{SRS}^{cs , m ax} - 1 )$$

excluding CS values in-use prior to hopping. With this proposed scheme, SRS will not suffer the same cross-SRS interference in the next hopping if the SRS in this hopping suffers cross-SRS interference.

Similarly, for a first enhanced scheme of Comb hopping, the Comb hopping set (i.e., the hopping set for Comb hopping) includes values {0, 1, . . . , K_{TC}−1}, but excludes the used or in-use Comb value(s), for the next hopping. That is, the set of transmission combs includes Comb values from 0 to (K_{TC}−1) excluding Comb value in-use prior to hopping.

As a second enhanced scheme of CS hopping, to further reduce collision probability, different restricted CS hopping sets may be configured for different UEs. A UE may determine the CS hopping set based on indicated bitmap. In an example with

$${n}_{SRS}^{cs , m ax} = 8 ,$$

the CS values for the first SRS port (CS values for other SRS port may be determined based on CS value of the first SRS port using legacy scheme defined in the technical specification) can be {0, 1, 2, 3} for UEs from the first TRP, {2, 3, 4, 5} for UEs from the second TRP, and {4, 5, 6, 7} for UEs from the third TRP. Thus, the bitmap can be [1 1 1 1 0 0 0 0], [0 0 1 1 1 1 0 0] and [0 0 0 0 1 1 1 1] for UEs from the three cooperative TRPs respectively, where ‘1’ is used to indicate valid CS values for hopping. With some non-overlapping CS values between hopping sets (for different UEs), the collision probability can be further reduced since there is no collision when non-overlapping CS values are used. In this second enhanced scheme, the set of CS values for a UE may be a restricted hopping set, being a subset of CS values from 0 to

$$( {n}_{SRS}^{cs , m ax} - 1 ) .$$

Similar to CS hopping, different restricted Comb hopping sets may be used for different UEs in a second enhanced Comb hopping scheme. A UE may determine the restricted Comb hopping set based on a bitmap signal indicating selection of elements for the restricted hopping set, where the restricted Comb hopping set is a subset of Comb values from 0 to (K_{TC}−1).

### Hopping Set of Initial Frequency Positions for Frequency Hopping

When frequency hopping is enabled, the frequency position for SRS transmission is determined by the frequency domain hopping pattern and n_{RRC} given by the higher-layer parameter freqDomainPosition if configured. To realize random frequency resource mapping, the initial frequency position (which may also be referred to as the initial frequency location) may be randomized when the new round of frequency hopping starts for the sounding bandwidth. In other words, the initial frequency position may be hopped by a random value but not a fixed valued defined by the higher-layer parameter freqDomainPosition, where the random value denotes the index of candidate initial frequency position, which may be defined based on minimum sounding bandwidth with 4 PRB as legacy system for higher-layer parameter freqDomainPosition or possible location for sounding units.

For n_{RRC}, it may be an integer ranging from 0 to 67 on account of the minimum sounding bandwidth with 4 PRB. With similar consideration in the case of pseduo hopping for initial frequency position with frequency hopping, the initial frequency position may be pseduo randomly hopped in the range from 0 to 67 with 4 RBs as the hopping unit if the sounding bandwidth and actual hopping granularity are not considered.

When the sounding bandwidth and actual hopping granularity are considered, the initial frequency position may be pseduo randomly hopped within the candidate hopping units in the sounding bandwidth, which may be determined based on hopping bandwidth determined by configured bₕₒₚ and configured granularity of hopping unit determined by configured B_{SRS}. The number of possible initial frequency positions is

$$N = {\prod }_{b = {b}_{hop}}^{{B}_{SRS}} {N}_{b} ,$$

where N_{b} may be determined based on Table 6.4.1.4.3-1 in TS38.211. For example, when C_{SRS}=13, B_{SRS}=2, bₕₒₚ=0 are configured, the number of possible initial frequency positions N=1×2×2=4, where the sounding bandwidth is 48 RBs and the minimum sounding unit has 12 RBs. The initial frequency position may be pseduo randomly hopped between these four possible initial frequency positions which constitute a set of initial frequency positions for frequency hopping in this example.

Similar to the second enhanced CS hopping scheme, different restricted initial frequency position sets may be configured for different UEs in an enhanced scheme for initial frequency location hopping. With non-overlapping initial frequency positions, the collision probability may be further reduced. The possible initial frequency positions in the set of initial frequency positions for frequency hopping, or the hopping set, may also be indicated by bitmap. ‘1’ in the bitmap may be used to indicate valid initial frequency position in the hopping set for hopping.

Hopping Set for Combination of CS Hopping, Comb Hopping and/or Initial Frequency Position Hopping

In an actual NR system, for example, the Comb number K_{TC} and associated

$${n}_{SRS}^{cs , m ax}$$

may be configured as 2 and 8 respectively for cell edge CJT UE to guarantee channel estimation performance. In such cases, the candidate number for hopping is limited, and this is not good to reduce collision probability for CS only hopping scheme or Comb only hopping scheme. That is, a CS-only hopping scheme or Comb-only hopping scheme may not be effective in reducing collision probability. The situation is even worse when multiple SRS antenna ports (e.g., 4 or 8 port SRS) are configured or some restrictions are made for the hopping set.

In addition, a large candidate number for initial frequency position in the case of frequency hopping means a large number of SRS symbols for full bandwidth sounding and this is not desirable for fast obtaining of full bandwidth CSI. Furthermore, for 4 port SRS, the CS and Comb are determined together for one SRS resource, where it may be better to use a hopping scheme with combination of CS hopping and Comb hopping for simplicity.

As a general scheme, SRS resource mapping hopping may be made with any combination of CS hopping, and/or Comb hopping and/or initial frequency location hopping in the case of frequency hopping. The candidate number in the hopping set may be the product of the numbers of possible CS values, Comb values and initial frequency positions. For the full hopping set, the candidate number in the hopping set can be

$${K}_{TC} \times {n}_{SRS}^{cs , m ax} \times N .$$

That is, the hopping set may be a combined set of CS values, transmission combs, and initial frequency locations, with combination values from 0 to

$$( {K}_{TC} \times {n}_{SRS}^{cs , m ax} \times N - 1 ) .$$

If one of CS values, transmission combs and initial frequency locations is not used, the combined set for CS values, transmission combs, and/or initial frequency locations is naturally eliminated with their corresponding candidates. For example, when combination for CS and Comb hopping is used, the hopping set may be a combined set of CS values and transmission combs with combined values from 0 to

$$( {K}_{TC} \times {n}_{SRS}^{cs , m ax} - 1 ) .$$

Similar concepts in the first or second enhanced scheme for CS hopping, and/or the first and second enhanced scheme for Comb hopping, and/or the enhanced scheme for initial frequency location hopping may be used in SRS resource mapping hopping based on combination. In these cases, the possible CS values, Comb values and/or initial frequency locations used for hopping may be determined according to the respective schemes used, and the hopping set, whose candidate number is the product of the numbers of possible CS values, Comb values and/or initial frequency positions, is a restricted hopping set, which is a subset of the full hopping set.

With hopping based on combination, the candidate number in the hopping set is increased and thus the collision probability may be reduced.

In an example, for 4 port SRS, combinations of CS and Comb are used for one SRS resource. When the Comb value is configured as ‘2’,

$${n}_{SRS}^{cs , m ax}$$

can determined as 8 based on Table 6.4.1.4.2-1. There are 16 (i.e., 8*2=16) possible combinations of Comb and CS used for the first SRS port (CS and Comb for other SRS ports may be determined based on the legacy scheme). If hopping is made on the combination set that excludes the used or collision combinations, the hopping set size for combination of Comb and CS is 2*8−6=10, where there are 2 combinations with full collision for 4 SRS ports and 4 combinations with partial collision for 2 SRS ports. In detail, in this example, the hopping candidates for the hopping set with combination for CS and Comb are given as follows:
candidate 1: {[0 0], [2 0], [4 0], [6 0]};
candidate 2: {[1 0], [3 0], [5 0], [7 0]};
candidate 3: {[2 0], [4 0], [6 0], [0]};
candidate 4: {[3 0], [5 0], [7 0], [1 0]};
candidate 5: {[4 0], [6 1], [0 0], [2 1]};
candidate 6: {[5 0], [7 1], [1 0], [3 1]};
candidate 7: {[6 0], [0 1], [2 0], [4 1]};
candidate 8: {[7 0], [1 1], [3 0], [5 1]};
candidate 9: {[0 1], [2 1], [4 1], [6 1]};
candidate 10: {[1 1], [3 1], [5 1], [7 1]};
candidate 11: {[2 1], [4 1], [6 1], [0 1]};
candidate 12: {[3 1], [5 1], [7 1], [1 1]};
candidate 13: {[4 1], [6 0], [0 1], [2 0]};
candidate 14: {[5 1], [7 0], [1 1], [3 0]};
candidate 15: {[6 1], [0 0], [2 1], [4 0]};
candidate 16: {[7 1], [1 0], [3 1], [5 0]}, where
the first and second elements in the [ ] denote the CS value and Comb value, respectively; the first to fourth elements in the { } denote the CS and Comb combination for 4 SRS ports, respectively.

If candidate 1 is used for one SRS transmission, candidates 1 and 3 (in full collision on 4 SRS ports) and candidates 5, 7, 13 and 15 (in partial collision on 2 SRS ports) are excluded from the next hopping set. Thus, the remaining 10 candidate constitute the hopping set. In this case, the hopping set includes a combined set of CS values and transmission combs with combination values from 0 to

$$( {K}_{TC} \times {n}_{SRS}^{cs , m ax} - 1 )$$

excluding combination values in-use (i.e. in full collision), or partially in-use (i.e., in partial collision), prior to hopping.

To align the hopping set for Comb and CS between gNb and UE, the hopping set for combination of CS and Comb may be sorted based on the CS value for SRS port 0, i.e., from small values to large values. If there is collision between a candidate combination for CS and Comb and the used combination of CS and Comb for any SRS port, the collided candidate combination of CS and Comb will be excluded in the hopping set for the next hop.

### Time Domain Hopping Granularity and Hopping Pattern

One or multiple symbols may be used for the transmission of one SRS resource. Multiple symbol SRS may be used in the following cases:
case 1: SRS repetition transmission;
case 2: SRS transmission with intra-slot frequency hopping;
case 3:8 port SRS transmission;
case 4: SRS transmission with repetition and intra-slot frequency hopping.

In principle, similar interference situation may be targeted for different antenna ports since DL CSI acquisition is obtained based on all the SRS ports. For multiple symbol SRS transmission with repetition or intra-slot hopping, interference situation between different OFDM symbols may be similar or different based on different requirements.

For pseudo randomized hopping scheme, different time domain hopping granularities may be used based on different requirements. In detail, it may include, for example:
per symbol hopping,
per symbol unit hopping (where one symbol unit includes multiple SRS symbols),
per consecutive SRS symbols in an SRS resource, i.e. nrofSymbols in the higher layer parameter resourceMapping,
per transmission occasion for the SRS resource, where transmission occasion is defined similar as SRS counter.

For CS and/or Comb hopping for 2 or 4 SRS ports, per SRS symbol hopping may be used. For 8 Tx SRS transmission and SRS with repetition transmission, randomized hopping may be made per SRS symbol unit, which includes multiple symbols, i.e., 2 symbols for 8 port SRS and r symbols for repetition. For multiple symbol SRS with intra-slot hopping or with combined intra-slot hopping and repetition, initial frequency position hopping may be made per consecutive SRS symbol in an SRS resource.

For random hopping pattern, it may be designed based on time domain hopping granularity. The pseudo randomized hopping pattern may be:
Scheme 1: Per symbol hopping

$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N$$

Scheme 2: Per symbol unit hopping

$$f = ( {\sum }_{m = 0}^{M - 1} c ( M ( {n}_{s , f}^{u} {N}_{symbol}^{slot} + {l}_{0} + ⌊ \frac{{l}^{′}}{r} ⌋ ) + m ) \times {2}^{m} ) mod N$$

Scheme 3: Per slot hopping

$$f = ( {\sum }_{m = 0}^{M - 1} c ( M ( {n}_{s , f}^{u} {N}_{symbol}^{slot} + {l}_{0} + ⌊ \frac{{l}^{′}}{{r}^{′}} ⌋ ) + m ) \times {2}^{m} ) mod N or$$

$$f = ( {\sum }_{m = 0}^{M - 1} c ( {Mn}_{s , f}^{u} + m ) \times {2}^{m} ) mod N$$

Scheme 4: per transmission occasion hopping for the SRS resource

$$f = ( {\sum }_{m = 0}^{M - 1} c ( {Mn}_{SRS} + m ) \times {2}^{m} ) mod N$$

where N is candidate number of the hopping set;
l₀ is the starting position in the time domain; and

$${n}_{s , f}^{u}$$

is the slot index;

$${N}_{symbol}^{slot}$$

is the symbol number per slot; l′ is the SRS symbol location relative to starting position l₀; c (i) is the pseudo-random Gold sequence defined in clause 5.2.1 of TS38.211 and shall be initialized with

$${c}_{init} = {n}_{ID}^{SRS}$$

at the beginning of each radio frame;
r is symbol number per symbol unit; r′ is consecutive SRS symbols in an SRS resource, i.e. nrofSymbols in the higher layer parameter resourceMapping;
n_{SRS} is the SRS counter defined in TS 38.211; for the case of an SRS resource configured as periodic or semi-persistent by the higher-layer parameter resourceType, the SRS counter is given by:

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

M is a design parameter which depends on actual value of N. In principle, M is designed to uniformly generate values in the range [0 N−1]. If N=2K, M can be equal to K. Otherwise, M is designed with 2^{M}>>N to guarantee almost uniform generation for all the values in the range [0 N−1]. For example, M is a minimum value satisfying 2^{M}>8×N. If N is a value less than 16, M=7 may be selected in the example.

The time domain granularity and corresponding pseudo hopping pattern may be defined by specific pseudo randomized hopping scheme. For simplicity, hopping pattern 2 (i.e., scheme 2) may be used as a common hopping pattern. Here, different values for r may be defined for different hopping schemes. Alternatively, the hopping granularity, i.e. r, in the time domain may be configured by RRC signalling.

### Enabling Signalling for SRS Resource Mapping Hopping

To obtain DL CSI acquisition by exploiting channel reciprocity, UE may be configured with the higher layer parameter usage in SRS-ResourceSet set as ‘antennaSwitching’. For some UEs with low capability, different Tx/Rx numbers may be used, such as 1T2R (i.e., one Tx transmission and 2 Rx transmissions), 1T4R, 1T8R, 2T4R, 2T8R, 4T8R, etc. Multiple SRS resources in one or more SRS resource set may be used to obtain DL channel corresponding to different Rx.

Therefore, it may be desirable to enable SRS resource mapping hopping for all these multiple SRS resources simultaneously for full DL CSI acquisition.

The signalling for enabling SRS resource mapping hopping may be used for SRS resources in one or more SRS-ResourceSet set with usage set as ‘antennaSwitching’.

For aperiodic SRS, one or more SRS resource sets with usage set as ‘antennaSwitching’ may be triggered for DL CSI acquisition. All SRS resources in these triggered SRS resource set(s) are enabled simultaneously for SRS resource mapping hopping.

In an example, signalling for enabling SRS resource mapping hopping and signalling for indicating actual hopping scheme may be designed with one new RRC signalling. The new RRC signalling, i.e., randomHopping, in SRS-ResourceSet, may be introduced, and an example of the signalling is illustrated below.

SRS-ResourceSet ::= SEQUENCE {
...
randomHopping ENUMERATED {csHopping, combHopping, initialRBHopping,
csAndcombHopping, csAndinitialRBHopping, combAndinitialRBHopping,
csAndcombAndinitialRBHopping}
OPTIONAL, -- Cond with usage setting as
antennaSwitching
...
}

When randomHopping is configured, the SRS resource mapping hopping is made based on the configured hopping scheme, such as:
csHopping, for CS hopping;
combHopping, for Comb hopping;
initialRBHopping, for initial frequency position hopping;
csAndcombHopping, for combination of CS hopping and Comb hopping
csAndinitialRBHopping, for combination of CS hopping and initial frequency position hopping;
combAndinitialRBHopping, for combination of Comb hopping and initial frequency position hopping;
csAndcombAndinitialRBHopping, for combination of CS hopping, Comb hopping, and initial frequency position hopping.

When randomHopping is not configured, the SRS resource mapping hopping is not enabled.

That is, in some examples, a separate hopping enabling signal is provided, for enabling the SRS resource mapping hopping for SRS resources in one or more sets of SRS-ResourceSet with usage set as ‘antennaSwitching’. In some other examples, no enabling signalling is required. The hopping scheme signalling, randomHopping, for indicating a scheme of SRS resource mapping hopping implicitly enables the SRS resource mapping hopping.

FIG. 5 is a flow chart illustrating steps of SRS resource mapping hopping by UE 200 in accordance with some implementations of the present disclosure.

At step 502, the receiver 214 of UE 200 receives a configuration signalling for Sounding Reference Signal (SRS) resource mapping hopping.

At step 504, the processor 202 of UE 200 determines a hopping set for SRS resource mapping hopping, wherein the hopping set comprises a set of Cyclic Shift (CS) values, a set of transmission combs, and/or a set of initial frequency locations for frequency hopping.

At step 506, the transmitter 212 of UE 200 transmits an SRS with hopping in the hopping set based on a randomized SRS resource mapping.

FIG. 6 is a flow chart illustrating steps of SRS resource mapping hopping by gNB 300 in accordance with some implementations of the present disclosure.

At step 602, the transmitter 312 of gNB 300 transmits a configuration signalling for Sounding Reference Signal (SRS) resource mapping hopping.

At step 604, the processor 302 of UE 300 determines a hopping set for SRS resource mapping hopping, wherein the hopping set comprises a set of Cyclic Shift (CS) values, a set of transmission combs, and/or a set of initial frequency locations for frequency hopping.

At step 606, the receiver 314 of gNB 300 receives an SRS with hopping in the hopping set based on a randomized SRS resource mapping.

In one aspect, some items as examples of the disclosure concerning UE may be summarized as follows:
1. An apparatus, comprising:
a receiver that receives a configuration signalling for Sounding Reference Signal (SRS) resource mapping hopping;
a processor that determines a hopping set for SRS resource mapping hopping, wherein the hopping set comprises a set of Cyclic Shift (CS) values, a set of transmission combs, and/or a set of initial frequency locations for frequency hopping; and
a transmitter that transmits an SRS with hopping in the hopping set based on a randomized SRS resource mapping.
2. The apparatus of item 1, wherein the set of CS values comprise CS values from 0 to

$$( {n}_{SRS}^{cs , m ax} - 1 ) ,$$

of CS values from 0 to

$$( {n}_{SRS}^{cs , m ax} - 1 )$$

excluding CS values in-use prior to hopping.
3. The apparatus of item 1, wherein the set of CS values is a restricted hopping set, being a subset of CS values from 0 to

$$( {n}_{SRS}^{cs , m ax} - 1 ) .$$

4. The apparatus of item 1, wherein the set of transmission combs comprise Comb values from 0 to (K_{TC}−1), or Comb values from 0 to (K_{TC}−1) excluding Comb value in-use prior to hopping.
5. The apparatus of item 1, wherein the set of transmission combs is a restricted hopping set, being a subset of Comb values from 0 to (K_{TC}−1).
6. The apparatus of item 1, wherein the hopping set comprises a combined set of CS values and transmission combs, with combination values from 0 to

$$( {K}_{TC} \times {n}_{SRS}^{cs , m ax} - 1 ) ,$$

or with combination values from 0 to

$$( {K}_{TC} \times {n}_{SRS}^{cs , m ax} - 1 )$$

excluding combination values in-use, or partially in-use, prior to hopping.
7. The apparatus of item 1, wherein the set of initial frequency locations comprises values from 0 to N−1, where

$$N = {\prod }_{b = {b}_{hop}}^{{B}_{SRS}} {N}_{b} .$$

8. The apparatus of item 1, wherein the hopping set comprises a combined set of CS values, transmission combs, and initial frequency locations, with combination values from 0 to

$$( {K}_{TC} \times {n}_{SRS}^{cs , m ax} \times N - 1 ) .$$

9. The apparatus of item 8, wherein the combined set is a restricted hopping set, being a subset of the combined set of CS values, transmission combs, and initial frequency locations, with combination values from 0 to

$$( {K}_{TC} \times {n}_{SRS}^{cs , m ax} \times N - 1 ) .$$

10. The apparatus of item 3, 5, or 9, wherein the receiver further receives a bitmap signal indicating selection of element for the restricted hopping set.
11. The apparatus of item 1, wherein the SRS resource mapping hopping is configured with time domain granularity of per symbol, per symbol unit, per slot, or per transmission occasion for the SRS resource; wherein the symbol unit comprise a symbol number (r) of symbols, where r≥2.
12. The apparatus of item 11, wherein the SRS resource mapping hopping is configured with a randomized hopping pattern comprising one of:

$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N ,$$

$$f = ( {\sum }_{m = 0}^{M - 1} c ( M ( {n}_{s , f}^{u} {N}_{symbol}^{slot} + {l}_{0} + ⌊ \frac{{l}^{′}}{r} ⌋ ) + m ) \times {2}^{m} ) mod N ,$$

$$f = ( {\sum }_{m = 0}^{M - 1} c ( M {n}_{s , f}^{u} + m ) \times {2}^{m} ) mod N , or$$

$$f = ( {\sum }_{m = 0}^{M - 1} c ( M {n}_{SRS} + m ) \times {2}^{m} ) mod N$$

where N is candidate number in the hopping set; and r is symbol number in the symbol unit.
13. The apparatus of item 12, wherein M=K, if N=2^{K}; or M is a minimum value satisfying 2^{M}>8×N, if N+2^{K}
14. The apparatus of item 11 or 12, wherein the symbol number (r) is: 2 for 8 Tx SRS, or SRS symbol number with repetition, or consecutive SRS symbols in an SRS resource configured by nrofSymbols, or a predefined value, or a value configured via RRC.
15. The apparatus of item 1, wherein the configuration signalling comprises a hopping enabling signal, for enabling the SRS resource mapping hopping for SRS resources in one or more sets of SRS-ResourceSet with usage set as ‘antennaSwitching’.
16. The apparatus of item 1, wherein the configuration signalling comprises a hopping scheme signalling for indicating a scheme of SRS resource mapping hopping, and the hopping scheme signal implicitly enables the SRS resource mapping hopping.

In another aspect, some items as examples of the disclosure concerning gNB may be summarized as follows:
17. An apparatus, comprising:
a transmitter that transmits a configuration signalling for Sounding Reference Signal (SRS) resource mapping hopping;
a processor that determines a hopping set for SRS resource mapping hopping, wherein the hopping set comprises a set of Cyclic Shift (CS) values, a set of transmission combs, and/or a set of initial frequency locations for frequency hopping; and
a receiver that receives an SRS with hopping in the hopping set based on a randomized SRS resource mapping.
18. The apparatus of item 17, wherein the set of CS values comprise CS values from 0 to

$$( {n}_{SRS}^{cs , m ax} - 1 ) ,$$

or CS values from 0 to

$$( {n}_{SRS}^{cs , m ax} - 1 )$$

excluding CS values in-use prior to hopping.
19. The apparatus of item 17, wherein the set of CS values is a restricted hopping set, being a subset of CS values from 0 to

$$( {n}_{SRS}^{cs , m ax} - 1 ) .$$

20. The apparatus of item 17, wherein the set of transmission combs comprise Comb values from 0 to (K_{TC}−1), or Comb values from 0 to (K_{TC}−1) excluding Comb value in-use prior to hopping.
21. The apparatus of item 17, wherein the set of transmission combs is a restricted hopping set, being a subset of Comb values from 0 to (K_{TC}−1).
22. The apparatus of item 17, wherein the hopping set comprises a combined set of CS values and transmission combs, with combination values from 0 to

$$( {K}_{TC} \times {n}_{SRS}^{cs , m ax} - 1 ) ,$$

or with combination values from 0 to

$$( {K}_{TC} \times {n}_{SRS}^{cs , ma x} - 1 ) .$$

excluding combination values in-use, or partially in-use, prior to hopping.
23. The apparatus of item 17, wherein the set of initial frequency locations comprises values from 0 to N−1, where

$$N = {\prod }_{b = {b}_{hop}}^{{B}_{SRS}} {N}_{b} .$$

24. The apparatus of item 17, wherein the hopping set comprises a combined set of CS values, transmission combs, and initial frequency locations, with combination values from 0 to

$$( {K}_{TC} \times {n}_{SRS}^{cs , m ax} \times N - 1 ) .$$

25. The apparatus of item 24, wherein the combined set is a restricted hopping set, being a subset of the combined set of CS values, transmission combs, and initial frequency locations, with combination values from 0 to

$$( {K}_{TC} \times {n}_{SRS}^{cs , ma x} \times N - 1 ) .$$

26. The apparatus of item 19, 21, or 25, wherein the transmitter further transmits a bitmap signal indicating selection of element for the restricted hopping set.
27. The apparatus of item 17, wherein the SRS resource mapping hopping is configured with time domain granularity of per symbol, per symbol unit, per slot, or per transmission occasion for the SRS resource; wherein the symbol unit comprise a symbol number (r) of symbols, where r≥2.
28. The apparatus of item 27, wherein the SRS resource mapping hopping is configured with a randomized hopping pattern comprising one of:

$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N , \\ f = ( {\sum }_{m = 0}^{M - 1} c ( M ( {n}_{s , f}^{u} {N}_{symbol}^{slot} + {l}_{0} + ⌊ \frac{{l}^{′}}{r} ⌋ ) + m ) \times {2}^{m} ) mod N , \\ f = ( {\sum }_{m = 0}^{M - 1} c ( {Mn}_{s , f}^{u} + m ) \times {2}^{m} ) mod N , or \\ f = ( {\sum }_{m = 0}^{M - 1} c ( {Mn}_{SRS} + m ) \times {2}^{m} ) mod N$$

where N is candidate number in the hopping set; and r is symbol number in the symbol unit.
29. The apparatus of item 28, wherein M=K, if N=2^{K}; or M is a minimum value satisfying 2^{M}>8×N, if N+2^{K}
30. The apparatus of item 27 or 28, wherein the symbol number (r) is: 2 for 8 Tx SRS, or SRS symbol number with repetition, or consecutive SRS symbols in an SRS resource configured by nrofSymbols, or a predefined value, or a value configured via RRC.
31. The apparatus of item 17, wherein the configuration signalling comprises a hopping enabling signal, for enabling the SRS resource mapping hopping for SRS resources in one or more sets of SRS-ResourceSet with usage set as ‘antennaSwitching’.
32. The apparatus of item 17, wherein the configuration signalling comprises a hopping scheme signalling for indicating a scheme of SRS resource mapping hopping, and the hopping scheme signal implicitly enables the SRS resource mapping hopping.

In a further aspect, some items as examples of the disclosure concerning a method of UE may be summarized as follows:
33. A method, comprising:
receiving, by a receiver, a configuration signalling for Sounding Reference Signal (SRS) resource mapping hopping;
determining, by a processor, a hopping set for SRS resource mapping hopping, wherein the hopping set comprises a set of Cyclic Shift (CS) values, a set of transmission combs, and/or a set of initial frequency locations for frequency hopping; and
transmitting, by a transmitter, an SRS with hopping in the hopping set based on a randomized SRS resource mapping.
34. The method of item 33, wherein the set of CS values comprise CS values from 0 to

$$( {n}_{SRS}^{cs , ma x} - 1 ) ,$$

or CS values from 0 to

$$( {n}_{SRS}^{cs , ma x} - 1 )$$

excluding CS values in-use prior to hopping.
35. The method of item 33, wherein the set of CS values is a restricted hopping set, being a subset of CS values from 0 to

$$( {n}_{SRS}^{cs , ma x} - 1 ) .$$

36. The method of item 33, wherein the set of transmission combs comprise Comb values from 0 to (K_{TC}−1), or Comb values from 0 to (K_{TC}−1) excluding Comb value in-use prior to hopping.
37. The method of item 33, wherein the set of transmission combs is a restricted hopping set, being a subset of Comb values from 0 to (K_{TC}−1).
38. The method of item 33, wherein the hopping set comprises a combined set of CS values and transmission combs, with combination values from 0 to

$$( {K}_{TC} \times {n}_{SRS}^{cs , ma x} - 1 ) ,$$

of with combination values from 0 to

$$( {K}_{TC} \times {n}_{SRS}^{cs , ma x} - 1 )$$

excluding combination values in-use, or partially in-use, prior to hopping.
39. The method of item 33, wherein the set of initial frequency locations comprises values from 0 to N−1, where

$$N = {\prod }_{b = {b}_{hop}}^{{B}_{SRS}} {N}_{b} .$$

40. The method of item 33, wherein the hopping set comprises a combined set of CS values, transmission combs, and initial frequency locations, with combination values from 0 to

$$( {K}_{TC} \times {n}_{SRS}^{cs , ma x} \times N - 1 ) .$$

41. The method of item 40, wherein the combined set is a restricted hopping set, being a subset of the combined set of CS values, transmission combs, and initial frequency locations, with combination values from 0 to

$$( {K}_{TC} \times {n}_{SRS}^{cs , ma x} \times N - 1 ) .$$

42. The method of item 35, 37, or 41, wherein the receiver further receives a bitmap signal indicating selection of element for the restricted hopping set.
43. The method of item 33, wherein the SRS resource mapping hopping is configured with time domain granularity of per symbol, per symbol unit, per slot, or per transmission occasion for the SRS resource; wherein the symbol unit comprise a symbol number (r) of symbols, where r≥2.
44. The method of item 43, wherein the SRS resource mapping hopping is configured with a randomized hopping pattern comprising one of:

$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N , \\ f = ( {\sum }_{m = 0}^{M - 1} c ( M ( {n}_{s , f}^{u} {N}_{symbol}^{slot} + {l}_{0} + ⌊ \frac{{l}^{′}}{γ} ⌋ ) + m ) \times {2}^{m} ) mod N , \\ f = ( {\sum }_{m = 0}^{M - 1} c ( {Mn}_{s , f}^{u} + m ) \times {2}^{m} ) mod N , or \\ f = ( {\sum }_{m = 0}^{M - 1} c ( {Mn}_{SRS} + m ) \times {2}^{m} ) mod N$$

where N is candidate number in the hopping set; and r is symbol number in the symbol unit.
45. The method of item 44, wherein M=K, if N=2^{K}; or M is a minimum value satisfying 2^{M}>8×N, if N+2^{K}
46. The method of item 43 or 44, wherein the symbol number (r) is: 2 for 8 Tx SRS, or SRS symbol number with repetition, or consecutive SRS symbols in an SRS resource configured by nrofSymbols, or a predefined value, or a value configured via RRC.
47. The method of item 33, wherein the configuration signalling comprises a hopping enabling signal, for enabling the SRS resource mapping hopping for SRS resources in one or more sets of SRS-ResourceSet with usage set as ‘antennaSwitching’.
48. The method of item 33, wherein the configuration signalling comprises a hopping scheme signalling for indicating a scheme of SRS resource mapping hopping, and the hopping scheme signal implicitly enables the SRS resource mapping hopping.

In a yet further aspect, some items as examples of the disclosure concerning a method of gNB may be summarized as follows:
49. A method, comprising:
transmitting, by a transmitter, a configuration signalling for Sounding Reference Signal (SRS) resource mapping hopping;
determining, by a processor, a hopping set for SRS resource mapping hopping, wherein the hopping set comprises a set of Cyclic Shift (CS) values, a set of transmission combs, and/or a set of initial frequency locations for frequency hopping; and
receiving, by a receiver, an SRS with hopping in the hopping set based on a randomized SRS resource mapping.
50. The method of item 49, wherein the set of CS values comprise CS values from 0 to

$$( {n}_{SRS}^{cs , ma x} - 1 ) ,$$

or CS values from 0 to

$$( {n}_{SRS}^{cs , m ax} - 1 )$$

excluding CS values in-use prior to hopping.
51. The method of item 49, wherein the set of CS values is a restricted hopping set, being a subset of CS values from 0 to

$$( {n}_{SRS}^{cs , m ax} - 1 ) .$$

52. The method of item 49, wherein the set of transmission combs comprise Comb values from 0 to (K_{TC}−1), or Comb values from 0 to (K_{TC}−1) excluding Comb value in-use prior to hopping.
53. The method of item 49, wherein the set of transmission combs is a restricted hopping set, being a subset of Comb values from 0 to (K_{TC}−1).
54. The method of item 49, wherein the hopping set comprises a combined set of CS values and transmission combs, with combination values from 0 to

$$( {K}_{TC} \times {n}_{SRS}^{cs , m ax} - 1 ) ,$$

or with combination values from 0 to

$$( {K}_{TC} \times {n}_{SRS}^{cs , m ax} - 1 )$$

excluding combination values in-use, or partially in-use, prior to hopping.
55. The method of item 49, wherein the set of initial frequency locations comprises values from 0 to N−1, where

$$N = {\prod }_{b = {b}_{hop}}^{{B}_{SRS}} {N}_{b} .$$

56. The method of item 49, wherein the hopping set comprises a combined set of CS values, transmission combs, and initial frequency locations, with combination values from 0 to

$$( {K}_{TC} \times {n}_{S R S}^{cs , m ax} \times N - 1 ) .$$

57. The method of item 56, wherein the combined set is a restricted hopping set, being a subset of the combined set of CS values, transmission combs, and initial frequency locations, with combination values from 0 to

$$( {K}_{TC} \times {n}_{SRS}^{cs , m ax} \times N - 1 ) .$$

58. The method of item 51, 53, or 57, wherein the transmitter further transmits a bitmap signal indicating selection of element for the restricted hopping set.
59. The method of item 49, wherein the SRS resource mapping hopping is configured with time domain granularity of per symbol, per symbol unit, per slot, or per transmission occasion for the SRS resource; wherein the symbol unit comprise a symbol number (r) of symbols, where r≥2.
60. The method of item 59, wherein the SRS resource mapping hopping is configured with a randomized hopping pattern comprising one of:

$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N ,$$

$$f = ( {\sum }_{m = 0}^{M - 1} c ( M ( {n}_{s , f}^{u} {N}_{symbol}^{slot} + {l}_{0} + ⌊ \frac{{l}^{′}}{r} ⌋ ) + m ) \times {2}^{m} ) mod N ,$$

$$f = ( {\sum }_{m = 0}^{M - 1} c ( {Mn}_{s , f}^{u} + m ) \times {2}^{m} ) mod N , or$$

$$f = ( {\sum }_{m = 0}^{M - 1} c ( {Mn}_{SRS} + m ) \times {2}^{m} ) mod N$$

where N is candidate number in the hopping set; and r is symbol number in the symbol unit.
61. The method of item 60, wherein M=K, if N=2^{K}; or M is a minimum value satisfying 2^{M}>8×N, if N≠2^{K}
62. The method of item 59 or 60, wherein the symbol number (r) is: 2 for 8 Tx SRS, or SRS symbol number with repetition, or consecutive SRS symbols in an SRS resource configured by nrofSymbols, or a predefined value, or a value configured via RRC.
63. The method of item 49, wherein the configuration signalling comprises a hopping enabling signal, for enabling the SRS resource mapping hopping for SRS resources in one or more sets of SRS-ResourceSet with usage set as ‘antennaSwitching’.
64. The method of item 49, wherein the configuration signalling comprises a hopping scheme signalling for indicating a scheme of SRS resource mapping hopping, and the hopping scheme signal implicitly enables the SRS resource mapping hopping.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus, comprising:
at least one memory; and
at least one processor coupled with the at least one memory and configured to cause the UE to:
receive a configuration signaling for Sounding Reference Signal (SRS) resource mapping hopping;
determine a hopping set for SRS resource mapping hopping, wherein the hopping set comprises a set of Cyclic Shift (CS) values, or a set of transmission combs, or a combination thereof; and
transmit an SRS with hopping in the hopping set based on a randomized SRS resource mapping.

2. The UE of claim 1, wherein the set of CS values comprises CS values from 0 to
$${〚 ( n 〛}_{SRS}^{cs , m ax} - 1 ) ,$$
or CS values from 0 to
$${〚 ( n 〛}_{SRS}^{cs , m ax} - 1 )$$
excluding CS values in-use prior to hopping.

3. The UE of claim 1, wherein the set of CS values is a restricted hopping set, being a subset of CS values from 0 to
$${〚 ( n 〛}_{SRS}^{cs , m ax} - 1 ) .$$

4. The UE of claim 1, wherein the set of transmission combs comprise Comb values from 0 to [symbol] (K [symbol] _{TC}−1), or Comb values from 0 to [symbol] (K [symbol] _{TC}−1) excluding Comb value in-use prior to hopping.

5. The apparatus UE of claim 1, wherein the set of transmission combs is a restricted hopping set, being a subset of Comb values from 0 to [(K]_{TC}−1).

6. The apparatus UE of claim 1, wherein the hopping set comprises a combined set of CS values and transmission combs, with combination values from 0 to (K_“TC”×n_“SRS”\hat{ }(“cs”, “max”)−1), or with combination values from 0 to (K_“TC”×n_“SRS”\hat{ }(“cs”, “max”)−1) excluding combination values in-use, or partially in-use, prior to hopping.

7. (canceled)

8. The apparatus UE of claim 1, wherein the hopping set comprises a combined set of CS values, transmission combs, and initial frequency locations, with combination values from 0 to (K_“TC”×n_“SRS”\hat{ }(“cs”, “max”)×N−1); or
wherein the combined set is a restricted hopping set, being a subset of the combined set of CS values, transmission combs, and initial frequency locations, with combination values from 0 to (K_“TC”×n_“SRS”\hat{ }(“cs”, “max”)×N−1).

9. The UE of claim 8, wherein the receiver further at least one processor is configured to cause the UE to receive a bitmap signal indicating selection of element for the restricted hopping set.

10. The UE of claim 1, wherein the SRS resource mapping hopping is configured with time domain granularity of per symbol, per symbol unit, per slot, or per transmission occasion for the SRS resource; wherein the symbol unit comprises a symbol number (r) of symbols, where r≥2.

11. The UE of claim 10, wherein the SRS resource mapping hopping is configured with a randomized hopping pattern comprising one of:
$$f = ( {\sum }_{m = 0}^{M - 1} c ( M ( {n}_{s , f}^{u} {N}_{symbol}^{slot} + {l}_{0} + {l}^{′} ) + m ) \times {2}^{m} ) mod N ,$$
$$f = ( {\sum }_{m = 0}^{M - 1} c ( M ( {n}_{s , f}^{u} {N}_{symbol}^{slot} + {l}_{0} + ⌊ \frac{{l}^{′}}{r} ⌋ ) + m ) \times {2}^{m} ) mod N ,$$
$$f = ( {\sum }_{m = 0}^{M - 1} c ( {Mn}_{s , f}^{u} + m ) \times {2}^{m} ) mod N , or$$
$$f = ( {\sum }_{m = 0}^{M - 1} c ( {Mn}_{SRS} + m ) \times {2}^{m} ) mod N$$
where N is candidate number in the hopping set; and r is a symbol number in the symbol unit;
wherein M=K, if N=2^{K}; or Mis a minimum value satisfying 2^{M}>8×N, if N≠2^{K}.

12. The UE of claim 11, wherein the symbol number (r) is: 2 for 8 Tx SRS, or SRS symbol number with repetition, or consecutive SRS symbols in an SRS resource configured by nrofSymbols, or a predefined value, or a value configured via RRC.

13. The UE of claim 1, wherein the configuration signaling comprises a hopping enabling signal, for enabling the SRS resource mapping hopping for SRS resources in one or more sets of SRS-ResourceSet with usage set as ‘antennaSwitching’; or
wherein the configuration comprises a hopping scheme signaling for indicating a scheme of SRS resource mapping hopping, and the hopping scheme signal implicitly enables the SRS resource mapping hopping.

14. A base station, comprising:
at least one memory; and
at least one processor coupled with the at least one memory and configured to cause the base station to:
transmit a configuration signaling for Sounding Reference Signal (SRS) resource mapping hopping;
determine a hopping set for SRS resource mapping hopping, wherein the hopping set comprises a set of Cyclic Shift (CS) values, or a set of transmission combs, or a combination thereof; and
receive an SRS with hopping in the hopping set based on a randomized SRS resource mapping.

15. A method performed by a user equipment (UE), the method comprising:
receiving a configuration signalling signaling for Sounding Reference Signal (SRS) resource mapping hopping;
determining a hopping set for SRS resource mapping hopping, wherein the hopping set comprises a set of Cyclic Shift (CS) values, or a set of transmission combs, or a combination thereof; and
transmitting an SRS with hopping in the hopping set based on a randomized SRS resource mapping.

16. A processor for wireless communication, comprising:
at least one controller coupled with at least one memory and configured to cause the processor to:
receive a configuration signaling for Sounding Reference Signal (SRS) resource mapping hopping;
determine a hopping set for SRS resource mapping hopping, wherein the hopping set comprises a set of Cyclic Shift (CS) values, or a set of transmission combs, or a combination thereof; and
transmit an SRS with hopping in the hopping set based on a randomized SRS resource mapping.

17. The processor of claim 16, wherein the set of CS values comprises CS values from 0 to
$${〚 ( n 〛}_{SRS}^{cs , m ax} - 1 ) ,$$
or CS values from 0 to
$${〚 ( n 〛}_{SRS}^{cs , m ax} - 1 )$$
excluding CS values in-use prior to hopping.

18. The processor of claim 16, wherein the set of CS values is a restricted hopping set, being a subset of CS values from 0 to
$${〚 ( n 〛}_{SRS}^{cs , m ax} - 1 ) .$$

19. The processor of claim 16, wherein the set of transmission combs comprise Comb values from 0 to [symbol] (K [symbol] _{TC}−1), or Comb values from 0 to [symbol] (K [symbol] _{TC}−1) excluding Comb value in-use prior to hopping.

20. The processor of claim 16, wherein the set of transmission combs is a restricted hopping set, being a subset of Comb values from 0 to [symbol] (K [symbol] _{TC}−1).

21. The processor of claim 16, wherein the hopping set comprises a combined set of CS values and transmission combs, with combination values from 0 to (K_“TC”×n_“SRS”\hat{ }(“cs”, “max”)−1), or with combination values from 0 to (K_“TC”×n_“SRS”\hat{ }(“cs”, “max”)−1) excluding combination values in-use, or partially in-use, prior to hopping.
